(19) United States
(12) Patent Application Publication
(10) Pub. No.: US 2009/0285961 A1
(43) Pub. Date: Nov. 19, 2009

(54) USE OF LUPIN BRAN IN HIGH-FIBRE FOOD PRODUCTS

(75) Inventor: Mark Tucek, Western Australia (AU)

Correspondence Address: NIXON & VANDERHYE, PC, 901 NORTH GLEBE ROAD, 11TH FLOOR, ARLINGTON, VA, 22203, US

(73) Assignee: GRAIN POOL PARTY LTD., West Perth, W.A. (AU)

(21) Appl. No.: 11/917,403

(22) PCT Filed: Jun. 15, 2006
(86) PCT No.: PCT/AU2006/000821

§ 371 Date: Dec. 13, 2007

(30) Foreign Application Priority Data
Jun. 17, 2005 (AU) 2005903177

(51) Int. Cl. A23L 1/308; A23L 1/20; A23P 1/00; A23L 1/10; A23P 1/12

(52) U.S. Cl. 426/550; 426/482

(57) ABSTRACT

A process for producing food-grade lupin bran including the steps of separating the lupin hulls from the seed kernels and milling the lupin hulls to from lupin bran with a particle size of between 10-4000 micrometers. A high-fibre food product is made from a dry ingredient mix comprising 1% to 50% by weight of food-grade lupin bran.

### FIELD OF THE INVENTION

The present invention relates to a process for producing food-grade lupin bran and a high-fibre food product containing food-grade lupin bran, and relates particularly, though not exclusively, to the use of lupin bran in high-fibre breakfast and snackfood products.

### BACKGROUND TO THE INVENTION

The addition of fibre to diets typical of affluent Western countries is widely promoted for its health benefits. Health authorities recognise that fibre intake is often below generally accepted minimum levels, and thus they encourage increased dietary fibre consumption. Benefits commonly attributed to adequate levels of dietary fibre include weight loss, reduced blood cholesterol, maintenance of intestinal function, reduced risk of colon cancer, and improved diabetes management. Consumers are responsive to the message of increased fibre intake and, as a consequence, a wide range of commercial food products have been formulated to deliver enhanced fibre levels.

Species of the Lupinus genus are a source of two distinct types of dietary fibre, being:
(a) The thick seed coat, comprising 10 to 30% of the seed weight. This percentage varies according to the species but 25% is a typical amount. The seed coat is also known as the “hull”, in animal feed applications, or as “bran” in potential food applications; and
(b) Kernel fibre, which comprises the cell wall component of the lupin seed kernel, or that part of the seed remaining after the seed coat has been removed. Kernel fibre accounts for about 30 to 40% of the kernel weight.

There are significant physical and chemical differences between lupin bran and kernel fibre. These relate to colour (respectively, brown versus white), chemical composition (respectively, cellulose/hemi-cellulose versus pectin-like material), functional characteristics (respectively, medium/low versus high water-binding capacity), and nutritional value (respectively, insoluble versus mix of soluble and insoluble fibres).

Western Australia is the world's largest producer of grain lupins, accounting for some 85% of the world's trade. Lupins have been mechanically dehulled in Western Australian on a commercial scale for approximately 20 years by firms associated with the animal stockfeed industry. Current production of hulls in Australia is of the order of about 10,000 tonnes per annum. Significant production of lupin hulls also occurs in Korea. In both Australia and Korea hulls are seen as a low-value by-product, with limited uses. The present applications for hulls are almost exclusively as a ruminant feedstock.

Many species of lupin have a high alkaloid content which results in a characteristically bitter taste making them unacceptable for human consumption, although the alkaloids can be removed by steeping the seeds in water. The development of genetically low-alkaloid or “sweet” lupin, Lupinus angustifolius, has for many years prompted the interest in lupins as an alternative food source for human consumption, but with limited success. The use of small quantities (typically 5-10% by weight) of lupin flour in a range of food products has been reported. Small quantities of lupin bran, estimated at 200 tonnes per annum, are used in Australia in a limited range of bread products for the purposes of fibre fortification. Limitations on significant uptake of lupin bran include its brown colour (a limitation because fibre-fortified breads are mostly white bread) and the relatively low concentration of added fibre that can be successfully incorporated without breads developing an unacceptable deterioration in quality.

The present invention was developed with a view to providing a high-fibre food product containing food-grade lupin bran and a process for producing food-grade lupin bran suitable for use in high-fibre food products.

References to prior art in this specification are provided for illustrative purposes only and are not to be taken as an admission that such prior art is part of the common general knowledge in Australia or elsewhere.

### SUMMARY OF THE INVENTION

According to one aspect of the present invention there is provided a high-fibre food product made from:

a dry ingredient mix comprising 1-50% by weight of food-grade lupin bran, the lupin bran being derived from the hulls of lupin seeds, and the hulls having undergone a pre-treatment process involving milling to a particle size of between 10-4000 micrometers.

Preferably the pre-treatment process involves milling to a particle size of between 50-1000 micrometers. More preferably, milling is to a particle size of about 150 micrometers.

It will be understood that the food product may contain other ingredients, such as water, flavourants, nuts, dried fruit, and so on, that may be added to the dry ingredient mix during processing at the appropriate stage, depending on the nature of the food product.

Preferably the lupin bran is mixed with one or more ground ingredients containing high starch levels to form the dry ingredient mix. Typically such high starch ground ingredients may be selected from the group comprising flours and/or coarse grits of wheat, barley, corn, rice, tapioca, potato, or triticale, or starch extracts of wheat, barley, corn, rice, tapioca, potato or triticale.

Preferably the dry ingredient mix comprises between about 20% and 50% by weight of lupin bran when the high-fibre food product is a breakfast cereal, and more preferably about 50:50 by weight ratio of rice flour:lupin bran. Preferably the dry ingredient mix comprises about 15%:85% of lupin bran: rice flour when the food product is a snack food.

Typically the high-fibre food product is an extruded food product. Preferably the high-fibre food product is an extruded breakfast cereal. Preferably the high-fibre food product is an extruded snackfood. Preferably the high-fibre food product is an extruded snackbar.

According to another aspect of the present invention there is provided a process for producing food-grade lupin bran, the process comprising the steps of:

separating the lupin hulls from the seed kernels; and
milling the lupin hulls to a particle size of between 10-4000 micrometers.

Preferably the particle size of the lupin bran after milling is between 50-1000 micrometers. More preferably the particle size of the lupin bran is about 150 micrometers. Typically the step of milling is accomplished with suitable equipment which may include a hammermill, and/or a cutter mill and/or a classifying mill and/or a pin mill.

According to a stilt further aspect of the present invention there is provided a process for producing a high-fibre food product, the process comprising the steps of:

preparing a dry ingredient mix comprising 1-50% by weight of food-grade lupin bran, the lupin bran being derived from the hulls of lupin seeds, and the hulls having undergone a pre-treatment process involving milling to a particle size of between 10-4000 micrometers;
adding additional ingredients simultaneous with or subsequent to preparation of the dry mix to produce a high-fibre mixture; and,
further processing the high-fibre mixture to produce a high-fibre food product.

Preferably the step of preparing the dry ingredient mix involves mixing the lupin bran with ground ingredients) containing high starch levels. Typically such high starch ground ingredients include flours and/or coarse grits of wheat, barley, corn, rice, tapioca, potato, triticale, and so on, or starch extracts of these.

Typically the step of further processing involves extrusion of the high-fibre mixture through an extrusion machine. The dry ingredient mix may have flavourants, e.g. commercial savoury mixes typically used in the production of snackfood products, added prior to extrusion or applied topically after extrusion. The dry ingredient mix may be preconditioned with water and/or heating prior to introducing to the extrusion machine. Water and/or heating may be added to the extruder barrel during the process of extrusion.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of preferred embodiments of the product and process of the invention, as well as the best method of performing the invention known to the inventor and applicants, given by way of example only, with reference to the accompanying drawing, in which:

FIG. 1 shows a flow diagram of an embodiment of the process to produce a high-fibre food product according to the invention.

### DETAILED DESCRIPTION OF PREFERRED EMBODIMENTS

The present invention is based on the surprising discovery that lupin bran which has undergone suitable pre-treatment can be used in a variety of high-fibre food products suitable for human consumption. This was an unexpected discovery as hitherto lupin hulls have been thought to be suitable only for animal stockfeed, except in the very limited case of low levels of inclusion in certain bread products. Pre-treatment of the lupin bran permits its inclusion in high-fibre food products such as extruded snackfoods, breakfast cereals, snackbars and biscuits to deliver dietary fibre levels of 1% to more than 50% (roughly equivalent to 1-50% inclusion rate). This compares with typical fibre levels of 5-10% associated with fibre enriched breads. Extruded snack foods, breakfast cereals, snackbars and biscuits thus provide novel methods for delivery of lupin bran at high levels of incorporation.

Extruded products containing lupin bran prepared according to the invention, even at high inclusion rates of for example greater than 40%, were found to be highly palatable, which is a surprising discovery since lupin hulls have not previously been considered a suitable food ingredient when incorporated in food formulations at high inclusion levels. Advantageously, lupin bran is a source of gluten-free dietary fibre. This contrasts with wheat-based bran fibre products, which dominate fibre enhanced foods, e.g. breakfast bran products. Hence pre-treated lupin bran provides an attractive alternative for producing high-fibre food products suitable for people who are allergic to gluten. High fibre breakfast products based on lupin bran also exhibit excellent food characteristics, such as long bowl life (i.e. the time a breakfast cereal takes to become soggy once the milk has been poured over it).

Preferably the process of producing food-grade lupin bran comprises the step of separating the lupin hulls from the seed kernels, and pre-treatment of the lupin hulls by milling to a particle size of between 10-4000 micrometers. Typically the pre-treatment involves milling of the lupin hulls in a hammermill, and/or a cutter mill and/or a classifying mill and/or a pin mill, to achieve a fineness of grind in the range of 10-1000 microns.

Standard techniques known in the art are used in the separation and milling steps but for the sake of clarity further details are provided in this regard. A variety of different lupin species may be used in the invention taking into consideration the characteristics of the lupins such as the colour of the hulls, ease of hulling, chemical composition and flavour. By way of example, lupins of the following species have been found to be suitable for use in the invention, Lupinus angustifolius, Lupinus albus and Lupinus luteus. Preferably, for the purposes of food safety, lupins for use in the invention should be sourced from growers who can certify the lupins as meeting recognised HACCP (Hazard Analysis Critical Control Point)-based Quality Assured standards.

As a first step, the lupin seed is preferably cleaned of all foreign material such as weed seeds, chaff, deformed seeds, and then size-graded. Commercial grain cleaning equipment such as sieves, vibratory screens, air aspiration, gravity tables, colour-sorting equipment and so on, is suitable for this purpose.

A heating step immediately prior to hulling may be performed to facilitate effective hulling. The aim of the heating step is to rapidly bring the seed coat to a temperature of about 80° C. The residence time of the seed in the heating step is minimal since the purpose of the heating step is to heat only the outside of the seed coat, leaving the centre of the seed largely unchanged. The heating step may be accomplished in various ways including, but not limited to, infra-red energy applications, an oven, a heated fluidised bed, and the application of steam. However, it is to be understood that the heating step is optional and the hulling of the lupin seeds may take place without any prior heat treatment.

Once the lupin seed has been cleaned of foreign material, size-graded and (optionally) heat treated, the seed is passed into any suitable commercial hulling machinery suitable for the purposes of separating the hull from the cotyledon. Examples of such commercial machinery include, but are not limited to, impact mills such as the Ripple Mill, abrasive mills, roller mills, and so on. Material from such mills is then passed into commercial grain aspiration equipment, where hulls are separated from the cotyledon material by the movement of air. After this process, hulls may be passed over sieves to separate any fine cotyledon material, as necessary, thereby maximising the purity of the hulls so produced.

The step of milling is carried out using standard techniques as employed in the food processing industry using one or more suitable mills as already described including a hammermill, and/or a cutter mill and/or a classifying mill and/or a pin mill. Milling is carried out to the required particle size. Depending on the type of mill employed, after milling, the bran material may be sifted on screens reflecting the maximum particle size desired, for example 100 or 150 microns. Particles passing over the screen may be recycled for further milling and sieving. In the case of certain mill types, such as a classifying mill, the separation of bran particles to the desired particle size may be accomplished integrally within the mill.

Several embodiments of high-fibre food products and a preferred process for producing food-grade lupin bran will now be described in more detail, by way of example only, with reference to the following examples.

### (1) High-Fibre Extruded Snackfood

The inventor has found that highly palatable extruded snackfoods (products similar to Cheezels—Registered trade mark of Arnott's SBAH Pty Ltd, Burger Rings and Twisties—Registered trade marks of Frito-Lay Trading Company GmbH), but with a unique health focus (high-fibre, gluten free) can be prepared with lupin bran.

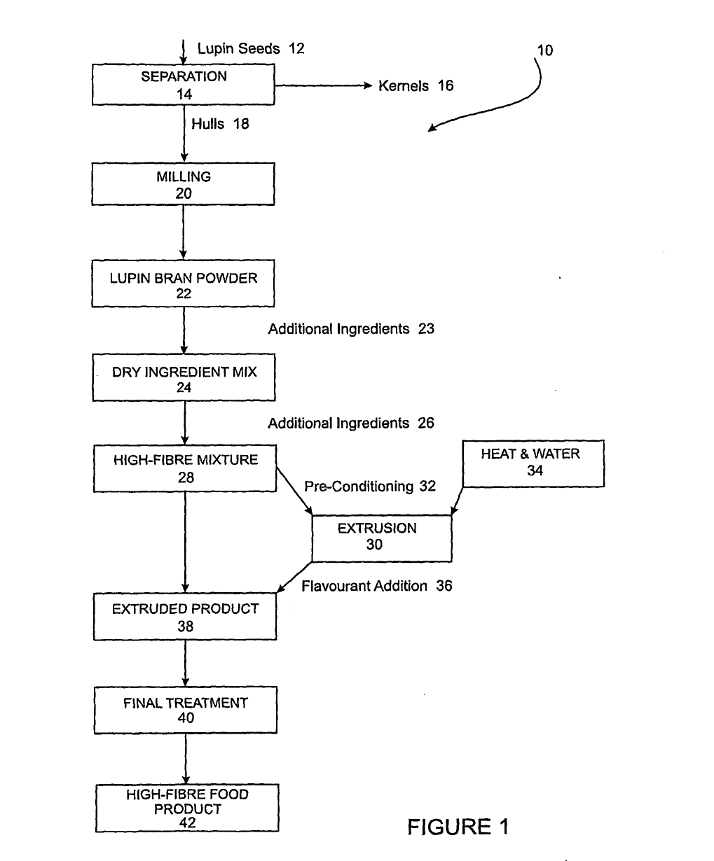

A process for the production of a high-fibre food product in the form of a snackfood will now be described generally with reference to FIG. 1. The hulls 18 of lupin seeds 12 are removed from the kernels 16 in a separation step 14 as previously described. Food-grade lupin bran 22 is prepared by milling 20. The typical particle size of the pre-treated lupin bran 22 is preferably between 50-1000 micrometers. More preferably the particle size of the pre-treated lupin bran is about 150 micrometers. The lupin bran powder 22 is then mixed with additional ground ingredient(s) 23 containing high starch levels (e.g. flours and/or coarse grits of wheat, barley, corn, rice, tapioca, potato, triticale, etc, or starch extracts of these) to form the dry ingredient mix 24. Lupin bran typically comprises 1-50% of the dry ingredient mix 24.

The dry ingredient mix 24 may have additional ingredients 26 such as flavourants, e.g. commercial savoury mixes typically used in the production of snackfood products, added prior to extrusion processing 30 to form the high-fibre mixture 28. Alternatively, such flavourants may be withheld from the dry ingredient mix and added post-extrusion as flavourant addition 36. The dry ingredient mix 24 or high-fibre mixture 28 may pass through a pre-conditioning step 32 by the addition of water and/or heating prior to introducing to the extrusion machine in the extrusion step 30. The temperature conditions of the pre-conditioning step may be varied but are typically about 70-100° C. In one example a temperature of 80-90° C. was used with a water injection rate of 180 kg water per 780 kg of dry mixture. The pre-conditioning step is carried out for a suitable length of time and typically for a time suitable to gelatinise the starch in the mixture.

Water and/or heating 34 may be added to the extruder barrel during the process of extrusion 30. Settings used on the extrusion machine such as barrel temperature(s), barrel pressure, screw speed, screw configuration, die design and configuration are set so as to produce products suited to various markets. Products may be prepared in the full range of high density (nil expansion) to low density (maximum expansion).

The extrusion step 30 produces an extruded product 38. Post extrusion, in the final treatment step 40, the extruded product 38 is cut to the desired size and shape, and dried and cooled. The product may also be lightly baked. At this stage the product may be coated with a flavourant, oil, etc and packaged to produce a high-fibre product 42 in the form of a snackfood. A similar process applies to the production of breakfast cereals, snackbars, biscuits and other like food products.

The preparation of one specific example of a high-fibre snackfood will now be described. The high-fibre expanded snackfood is prepared by combining 15% of ground (<150 micron) lupin bran combined with 85% of rice flour in the form of rice grits, or a combination of rice grits and maize semolina. This mixture is mixed until uniform, and then introduced to an extruder (single or twin screw) with the following process conditions: barrel inlet temperature of 90° C., outlet barrel temperature of 180° C.; screw speed 400 r.p.m.; die diameter 3.3 mm; die pressure 330 p.s.i. Extrusion conditions are set to maximise the gelatinisation of starch in the raw materials and to produce considerable volumetric expansion of extrudate at the die face due to the flashing-off of super-heated steam when the extrudate is exposed to atmospheric pressure. Water is injected into the extruder barrel concurrently with the dry feed mix (high-fibre mixture) at the rate of 180 kg water per 780 kg of dry feed. Alternatively, this ratio of water to dry feed can be applied in a pre-conditioning step prior to introduction to the extruder. In this latter case, some or all of the water can be added in the pre-conditioning step in the form of steam in order to pre-cook and partially gelatinise starch immediately prior to extrusion.

Immediately upon exiting the extruder die, the extruded product may be cut to desired length with a rotary knife placed close to the face of the die, or other suitable method. The extruded product, thus cut to length is conveyed to a dryer/cooler, as typically found in food production systems, from which dried, and stable, yet unflavoured snackfood cores emerge. Passing directly from the dryer, at a temperature of approximately 60° C., these cores pass into a heated rotating mixer, or similar suitable mixing system, where commercial flavourings (such as chili BBQ, sour cream and chives, cheese flavour, salt and vinegar, etc) are sprayed on to the cores as a heated (60° C.) solution of flavourings in edible food oil. Alternatively, the heated oil is sprayed onto the cores and powdered flavourings are dusted on concurrently, while the snackfood is tumbled to ensure even application of the flavour agent and oil. An alternative variation is where the flavourings are combined with the dry feed mix prior to the mixture being extruded (as already explained as step 26 in FIG. 1), or preconditioned (if this step is incorporated into the process). In this alternative case, heated oil can be sprayed onto the snack food cores after their exit from the dryer. Quantities of flavouring mix and oil could be in the range of 15% and 18% of the finished snackfood composition, but these proportions are entirely flexible depending on the product specifications desired. Following application of flavouring and oil, the finished snackfood is cooled, if necessary and packaged.

### (2) High-Fibre Extruded Breakfast Cereal

The inventor has found that highly palatable extruded high-fibre breakfast cereals (products similar to Kellogg's All-bran and a high-fibre version of Nutrigrain—Registered Trade Marks of the Kellogg's Company) can be prepared with lupin bran.

Food-grade lupin bran is prepared by milling. Typical particle size of the pre-treated lupin bran is preferably between 50-1000 micrometers. More preferably the particle size of the pre-treated lupin bran is about 150 micrometers. Lupin bran powder is then mixed with ground ingredient(s) containing high starch levels (e.g. flours of wheat, barley, corn, rice, tapioca, potato, etc, or starch extracts of these) to form the dry ingredient mix. Lupin bran may comprise 1%-50% of the dry ingredient mix.

The dry ingredient mix may have flavourants, e.g. a range of sweeteners and flavour such as malt extract, added prior to extrusion processing or added in the liquid phase during extrusion. Alternatively, such flavourants may be withheld from the dry ingredient mix and added post-extrusion. An example would be the spray application of a glaze solution onto extruded pellets, followed by drying and cooling.

The dry ingredient mix may be preconditioned with water and/or heating prior to introducing to the extruding machine. Water and/or heating may be added to the extruder barrel during the process of extrusion. Settings used on the extrusion machine such as barrel temperature(s), barrel pressure, screw speed, screw configuration, die design and configuration are set so as to produce products suited to various markets. Extruded products may be prepared in the full range from high density (nil expansion) to low density (maximum expansion).

One specific example of a breakfast cereal made according to the invention will now be described. For a high-fibre breakfast cereal, a dry ingredient mix of 50:50 by weight of rice flour to lupin bran is thoroughly combined into a homogeneous mixture prior to its introduction to a single-screw or twin-screw extruder. Extruder settings are as follows: barrel inlet temperature of 90° C.; die temperature of 130° C.; die pressure 140 p.s.i; dry mix feed rate of 380 kg/hr; liquid feed rate of 210 kg/hr. The liquid, which is injected into the extruder barrel concurrently with the dry feed mixture has the following composition in order to impart a desirable flavour to the breakfast cereal: salt 0.9%, sugar 21.7%, malt extract 8.1%, water 69.3%. However, it is to be understood that these quantities can be varied according to the requirements of the specific breakfast cereal.

Immediately upon exiting the extruder die, the extruded breakfast cereal product may be cut to desired length with a rotary knife placed close to the face of the die, or other suitable method. The product, cut to length in this way is conveyed to a dryer/cooler, as typically found in food production systems. The final high-fibre food product is then packaged, as required. The dietary fibre content of a breakfast cereal prepared in this way is around 38%.

Alternatively, flavourings can be withheld from the liquid injected into the extruder barrel so that the product exiting the dryer/cooler will be bland in taste. This can be a breakfast cereal product in its own right, being very high in fibre (typically around 50%) and low in sugar. Alternatively, un-flavoured product exiting the extruder, once cut to length but prior to entering the dryer/cooler, can have flavouring added to its external surface by being sprayed in a rotary mixer, with a concentrated glaze comprising salt, sugar and malt extract in the ratio 0.9:21.7:8.1, dissolved in water. Product treated in this manner is passed through a dryer/cooler prior to packaging.

### (3) High-Fibre Extruded Snackbars

Snackbars (such as muesli bars, fruit and nut bars, and so on) can be reformulated as highly palatable fibre fortified variants in accordance with the invention with the addition of 1-40% of lupin bran within the particle size range of 50-4000 micrometers having undergone either grinding or rolling in a roller mill as a pre-treatment. The process for the preparation of snackbars resembles the process for the production of snackfoods as shown in FIG. 1 and will not be described in further detail.

### (4) High-Fibre Baked Biscuits

Cracker biscuits (similar to Salada—Registered trade mark of Campbell Soup Company, Ryvita—Registered trade mark of George Weston Foods Limited, etc) and sweet biscuits can be reformulated as highly palatable fibre fortified variants in accordance with the invention with the addition of 1-40% of lupin bran within the particle size range of 50-4000 micrometers having undergone either grinding or rolling in a roller mill as a pre-treatment. The process for the preparation of biscuits resembles the process for the production of snackfoods as shown in FIG. 1 except that a final cooking step is usually employed in the case of biscuits, preferably by means of baking in an oven.

Now that several embodiments of the invention have been described in detail it will be apparent that high-fibre food products in accordance with the invention provide a number of advantages over the prior art, including the following:

(i) Pre-treatment permits lupin bran to be incorporated into extruded food products without loss of palatability, even at high inclusion rates, for example at rates of greater than 40%.
(ii) Since the lupin bran is gluten-free, it can be used as a healthy alternative to wheat-based fibre products. This is particularly important in the case of breakfast cereals since the vast majority of existing high-fibre breakfast cereal products are based on wheat bran.
(iii) The inclusion of lupin bran at such high levels in high-fibre food products greatly expands the scope for volume bran sales into various food systems.
(iv) The invention provides a way of incorporating very high fibre levels into palatable foods such as breakfast cereals. As an example, in the case of breakfast cereals produced with flavourant added externally as a spray-on glaze, products have about 38% dietary fibre content, whereas the unflavoured product contains about 50% dietary fibre.
(v) Breakfast cereals prepared according to the invention have superior “bowl life”, that is the time taken for the cereal to become soggy after milk is added is greater than in the case of many wheat-bran high fibre cereal products currently on the market.

It will be readily apparent to persons skilled in the relevant arts that various modifications and improvements may be made to the foregoing embodiments, in addition to those already described, without departing from the basic inventive concepts of the present invention. The described examples are given for illustrative purposes only and therefore it will be appreciated that the scope of the invention is not limited to the specific embodiments described.

1. A high-fibre food product made from:
a dry ingredient mix comprising 1% to 50% by weight of a food-grade lupin bran, the lupin bran being derived from the hulls of lupin seeds and the hulls having undergone a pre-treatment process involving milling to a particle size of between 10 micrometers to 4000 micrometers.

2. The high-fibre food product according to claim 1 wherein the pre-treatment process involves milling to a particle size of between 50 micrometers to 1000 micrometers.

3. The high-fibre food product according to claim 2 wherein the pre-treatment process involves milling to a particle size of about 150 micrometers.

4. The high-fibre food product according to claim 1 wherein the dry ingredient mix further comprises at least ingredient selected from a group consisting of water, flavourants, nuts and dried fruit.

5. The high-fibre food product according to claim 1 wherein the lupin bran is mixed with one or more ground ingredients, the ground ingredients containing high starch levels to form the dry ingredient mix.

6. The high-fibre food product according to claim 5 wherein the ground ingredients are selected from a group consisting of flours; coarse grits of at least one of wheat, barley, corn, rice, tapioca, potato and triticale; and starch extracts of at least one of wheat, barley, corn, rice, tapioca, potato, and triticale.

7. The high-fibre food product according to claim 1 wherein the dry ingredient mix comprises between about 20% and about 50% by weight of lupin bran, when the high-fibre food product is a breakfast cereal.

8. The high-fibre food product according to claim 6 wherein the dry ingredient mix comprises a ratio of about 50%/50% by weight ratio of rice flour to lupin bran, when the food product is a breakfast cereal.

9. The high-fibre food product according to claim 6 wherein the dry ingredient mix comprises a ratio of about 15%/85% of lupin bran to rice flour, when the food product is a snack food.

10. The high-fibre food product according to claim 1 wherein the high-fibre food product is an extruded food product.

11. The high-fibre food product according to claim 10 wherein the high-fibre food product is an extruded breakfast cereal.

12. The high-fibre food product according to claim 10 wherein the high-fibre food product is an extruded snackfood.

13. The high-fibre food product according to claim 10 wherein the high-fibre food product is an extruded snack bar.

14. A process for producing food-grade lupin bran, the process comprising the steps of:
separating the lupin hulls from the seed kernels; and
milling the lupin hulls to a particle size of between 10 micrometers to 4000 micrometers.

15. The process according to claim 14 wherein the particle size of the lupin bran after milling is between 50-1000 micrometers.

16. The process according to claim 15 wherein the particle size of the lupin bran is about 150 micrometers.

17. The process according to claims 14 wherein the step of milling is accomplished using at least one of a hammermill, a cutter mill a classifying mill, and a pin mill.

18. A process for producing a high-fibre food product, the process comprising the steps of:
preparing a dry ingredient mix comprising 1% to 50% by weight of a food-grade lupin bran, the lupin bran being derived from the hulls of lupin seeds, and the hulls having undergone a pre-treatment process involving milling to a particle size of between 10 micrometers to 4000 micrometers;
adding additional ingredients, and
further processing the high-fibre mixture to produce the high-fibre food product.

19. The process according to claim 18 wherein the step of preparing the dry ingredient mix involves mixing the lupin bran with one or more ground ingredients containing high starch levels.

20. The process according to claim 19 wherein the ground ingredients are selected from a group consisting of flours; coarse grits of at least one of wheat, barley, corn, rice, tapioca, potato and triticale, and starch extracts of wheat, barley, corn, rice, tapioca and potato.

21. The process according to claim 18 wherein the step of further processing involves extrusion of the high-fibre mixture through an extrusion machine.

22. The process according to claim 21 wherein flavourants are added to the dry ingredient mix prior to extrusion.

23. The process according to claim 21 wherein the flavourants are added to the dry ingredient mix topically after extrusion.

24. The process according to claims 21 wherein the dry ingredient mix is preconditioned with at least one of water and heating prior to introducing to the extrusion machine.

25. The process according to claim 21 wherein at least one of water and heating is added to an extruder barrel of the extrusion machine during the process of extrusion.

26-28. (canceled)
